(19) United States
(12) Patent Application Publication
(10) Pub. No.: US 2026/0021696 A1
(43) Pub. Date: Jan. 22, 2026

(54) Plastic Fuel Tank With Supporting Element

(71) Applicant: TI Automotive Technology Center GmbH, Rastatt (DE)

(72) Inventors: Moez Haouala, Karlsruhe (DE); Richard Cerini, Rochester Hills, MI (US); Peter Bleier-Bost, Graben- Neudorf (DE); Dennis Schwager, Karlsruhe (DE)

(21) Appl. No.: 18/870,272

(22) PCT Filed: Sep. 25, 2024
(86) PCT No.: PCT/EP2024/076946

§ 371 Date: Nov. 27, 2024

(30) Foreign Application Priority Data
Sep. 26, 2023 (EP) 23199703.2

(51) Int. Cl. B60K 15/03

(52) U.S. Cl. CPC B60K 15/03177; B60K 2015/03032; B60K 2015/03493

(57) ABSTRACT

A plastic fuel tank for a vehicle, the plastic fuel tank including a bottom part and a top part; at least one side wall extending between the bottom part to the top part; at least one supporting element. The at least one supporting element has an elongated shape and includes a longitudinal axis, includes a first end side and a second end side in its axial ends, includes a flange at the first end side or the second end side. The flange includes a flange width, and is arranged between the bottom part and the top part; wherein the top part or the bottom part includes an integrated receiving structure for receiving the flange of the supporting element. The receiving structure is formed by the top part or the bottom part, and forms a stepped cavity including a first cavity and a second cavity.

### CROSS-REFERENCE TO RELATED APPLICATIONS

This application is the United States national phase of International Patent Application No. PCT/EP2024/076946 filed Sep. 25, 2024, and claims priority to European Patent Application No. 23199703.2 filed Sep. 26, 2023, the disclosures of which are hereby incorporated by reference in their entireties.

### BACKGROUND OF THE INVENTION

### Field of the Invention

The present invention relates to a plastic fuel tank for a vehicle, as well as a motorized vehicle comprising said fuel tank, and a method for manufacturing the fuel tank.

Fuel tanks are generally known from the prior art in various types. Typically, a fuel tank is made of a plastic material or a metal. In particular, when a fuel tank is made of a plastic material, the mechanical stiffness of the tank may be rather low due to the material properties and the relatively low thickness of the tank body. In order to provide a higher stiffness of plastic fuel tanks, supporting elements (also referred to stiffening elements or reinforcing elements) may be provided that allow to absorb a mechanical force applied on the fuel tank. These supporting elements may have a longitudinal form and may be made of a plastic material.

### Description of Related Art

According to common plastic fuel tanks, the supporting elements are frequently made of a thermoplastic material, wherein the supporting elements are welded to a bottom part and a top part of the fuel tank. Typically, the supporting elements are made of the same material as the fuel tank, thus providing the same melting temperature, whereby the welding process is simplified.

While the mentioned fuel tanks including supporting elements being connected to the fuel tank body via welded joints comprise several benefits, these type of fuel tanks are also linked with some drawbacks. For instance, the manufacturing process is usually challenging and time-consuming, since the connection of the supporting elements to the tank body is sensitive to any movements of the supporting elements during the welding process.

### SUMMARY OF THE INVENTION

In view of the above, it is one object of the present invention to provide a plastic fuel tank that allows to be manufactured in an easy and efficient manner. Another object of the present invention is to provide a plastic fuel tank which can be produced with low manufacturing costs. A further object of the present invention is to provide a plastic fuel tank having an increased mechanical stiffness.

In order to solve the above-mentioned objects, a plastic fuel tank for a vehicle is provided with the present invention, wherein the plastic fuel tank comprises the following:
a bottom part and a top part;
at least one side wall extending between the bottom part and the top part, wherein the bottom part, the top part and the at least one side wall define an inner space of the plastic fuel tank, the inner space being configured to receive fuel;
at least one supporting element, wherein the at least one supporting element
   has an elongated shape and comprises a longitudinal axis;
   comprises a first end side and a second end side at its axial ends;
   comprises a flange at the first end side or the second end side, wherein the flange comprises a flange width;
   is arranged between the bottom part and the top part;
wherein the top part or the bottom part comprises an integrated receiving structure for receiving the flange of the supporting element, wherein the receiving structure
   is formed by the top part or the bottom part;
   forms a stepped cavity comprising a first cavity and a second cavity; wherein
      the first cavity is defined by an outer part of the top part or the bottom part forming a first cavity outer wall and at least one first cavity side wall extending from the first cavity outer wall; wherein the first cavity is arranged adjacent to the second cavity;
      the second cavity is defined by at least a second cavity side wall, and the second cavity is arranged between the first cavity and the inner space of the plastic fuel tank;
      the first cavity comprises a first cavity width, and the second cavity comprise a second cavity width, wherein the first cavity width is larger than the second cavity width; and
wherein the flange width is larger than the second cavity width and smaller or equal to the first cavity width.

The plastic fuel tank according to the present invention allows a stable attachment of the supporting element with the plastic fuel tank. Furthermore, according to the present invention, it is not mandatory to weld the outer surfaces of the supporting element with the top part and the bottom part of the fuel tank, which simplifies the manufacturing process. In this way, the manufacturing costs are reduced and the manufacturing velocity is increased.

The at least one side wall may be designed as a ring-shaped wall surrounding the inner space of the fuel tank. According to some embodiments, the fuel tank can also comprise several side walls, e.g. four side walls arranged rectangularly to each other forming the inner space of the fuel tank. It is also possible that the fuel tank comprises more than four side walls abutting each other and forming the inner space of the fuel tank. The present invention can be implemented regardless of the number of the side walls.

The supporting element is configured to support the fuel tank in case of an overpressure and/or an underpressure, thus preventing or at least reducing the likelihood of a destruction or a fracture of the fuel tank. The supporting element further reduces the likelihood of possible cracks in the top part and the bottom part of the fuel tank. Hence, the supporting element contributes to an increased stiffness and, as a consequence, to an increased lifespan of the fuel tank. According to the present invention, several supporting elements may be provided, depending on the size and the specific design of the fuel tank, wherein the present invention may be implemented regardless of the specific number of the supporting elements.

The flange of the supporting element may be designed as an integrated part of the supporting element or, alternatively, as a separate part being connected to a body of the supporting element. In the latter case, the flange may be welded or mechanically connected to the body of the supporting element. According to the present invention, a flange is provided at the first end side and/or at the second end side of the supporting element, and comprises a larger width when compared to the adjacent part of the supporting element. According to some embodiments, one flange may be provided being received in a receiving structure in the top part or the bottom part. In preferred embodiments of the present invention, a supporting element comprises one flange at each of its end sides, wherein one flange is received in a first receiving structure formed in the top part and one flange is received in a second receiving structure in the bottom part of the fuel tank.

According to some embodiments of the present invention, the supporting element and the flange may have a rotationally symmetric form, wherein the flange may preferably comprise a disk-shape. In the latter case, the first cavity and the second cavity may have a cylindrical shape, wherein the diameter of the first cavity is larger than the diameter of the second cavity. According to some embodiments, the stepped cavity may comprise a second cavity having uniformly reduced width when compared to the first cavity. For instance, the first cavity and the second cavity may each comprise a cylindrical shape, wherein the diameter of the second cavity is 10%, 20%, 30% or 50% reduced when compared to the first cavity. According to some embodiments, the second cavity may not comprise a rotationally cylindrical shape, wherein the width of the second cavity is reduced when compared to the first cavity at least along one cross-section of the stepped cavity. By providing the receiving structure comprising a stepped cavity with a first cavity and a second cavity (having a smaller width when compared to the first cavity), the flange can be locked inside the receiving structure and fixed therein in a mechanically stable manner.

The outer part of the top part or the bottom part describes a part of a top part or the bottom part which has a larger distance to the inner space of the tank when compared to the first cavity side wall and the second cavity side wall. In particular, the outer part may refer to a part of the top part or the bottom part comprising the largest distance to the inner space of the fuel tank.

Preferably, the sidewall, the bottom part and the top part are integrally designed. In addition, the first cavity side wall, the second cavity side wall and the outer part of the top part of the bottom part and may be integrally designed. Hence, the design of the fuel tank can be simplified and, as a consequence, the manufacturing costs can be further reduced.

According to preferred embodiments of the present invention, the flange comprises an outer surface being directed away from the axial center of the supporting element, wherein the outer surface of the flange is welded to the outer part of the top part or the bottom part. Hence, a more stable fixation of the supporting element within the receiving structure can be provided. In addition, according to this embodiment, the receiving structure can significantly assist the welding process by positioning the flange into the desired position and by keeping the flange in the desired position during the welding process. Hence, the alignment of the supporting element during the welding process is significantly improved.

According to some embodiments of the present invention, the height of the first cavity is smaller than or equal to the height of the flange. Hence, the flange is clamped inside the first cavity in an axial direction, whereby the mechanical stability of the fixation is significantly improved. According to some embodiments, the height of the first cavity is equal to the height of the flange. However, the height of the first cavity can also be chosen to be slightly smaller than the height of the flange. In the latter case, the clamping force induced by the receiving structure is increased. It is noted that the top part is usually formed by a rather thin plastic structure. Hence, the receiving structure typically comprises some flexibility, such that the flange can also be received in the first cavity if the height of the flange is somewhat larger than the height of the first cavity. In addition, when the flange is further welded to the top part or the bottom part of the fuel tank, providing a first cavity with a height being slightly smaller than the height of the flange, the resulting clamping force leads to an improved welding process, since and axial clamping force is applied to the flange by the receiving structure, pressing the flange and the top part of the bottom part of the fuel tank together during the welding process. This leads to an improved welding process and a more stable attachment between the supporting element and the top part and/or the bottom part of the fuel tank.

According to some embodiments of the present invention, the width of the first cavity may be larger than the width of the flange. According to some preferred embodiments of the present invention, the width of the first cavity may be equal to the width of the flange. As a consequence of the width of the first cavity being equal to the width of the flange, the flange is clamped inside the first cavity of the receiving structure in a radial direction. This enables a stable fixing of the flange in the radial direction within the first cavity of the receiving structure. In addition, if the outer surface of the flange is welded to the outer part of the top part or the bottom part, the fixation of the supporting element in a radial direction enables a simplified welding process, since the flange of the supporting element is kept in a radially stable position during the welding process.

According to some further preferred embodiments of the present invention, the first cavity comprises a tapered form, wherein the width of the first cavity decreases in a direction from the first cavity outer wall to the second cavity. Hence, the flange is centered within the first cavity in a radial direction when received in the first cavity.

In addition, the flange may also comprise a tapered shape, wherein the width of the flange decreases in a direction from its outer surface to the axial center of the supporting element. The tapering angle can be chosen in accordance with the tapering angle of the first cavity. In other words, the tapering angles can be chosen identically or at least similarly. Hence, the radial centering of the flange inside the first cavity can be improved.

According to some preferred embodiments of the present invention, the supporting element comprises a rotationally symmetrical shape. In addition, the first cavity, the second cavity and the flange may comprise a rotationally symmetrical shape.

Preferably, the supporting element comprises a tapered shape, wherein the width of the supporting element decreases from its axial ends to its axial center. Hence, the supporting element may intentionally break at a predetermined point, in case an increased force acts on the fuel tank, e.g. during an accident.

According to some preferred embodiments of the present invention, the supporting element comprises at least one breaking point configured to break when an axial force exceeding a predetermined force threshold is applied to the supporting element. The breaking point may be ensured by providing a notch at a specific position of the supporting element. The depth of the notch can be adjusted depending on the chosen force threshold.

According to further preferred embodiments of the present invention, the side wall, the bottom part and the top part of the fuel tank are integrally formed. Hence, the structure of the fuel tank is simplified and the manufacturing costs can be reduced.

According to further embodiments of the present invention, the side wall, the bottom part and the top part are made at least partly of a thermoplastic material. In addition, the supporting element and the receiving structure may be made of a thermoplastic material.

According to some preferred embodiments of the present invention, the side wall, the bottom part and the top part are made at least partly of one of the following materials: polyethylene (PE), high-density polyethylene (HDPE), polypropylene (PP), polyethylene terephthalate (PET), polystyrene (PS), polymethyl methacrylate (PMMA), polyoxymethylene (POM), polyphenylensulfis (PPS), polyphthalamide (PPA), polyether ether ketone (PEEK), polyamide-imides (PAI), or polyaryletherketone (PAEK). According to further embodiments of the present invention, the supporting element and/or the receiving structure can be made at least partly of one of the mentioned materials.

According to some embodiments of the present invention, the fuel tank is designed as a single tank or as a saddle tank.

According to the present invention, a motorized vehicle is suggested, wherein the motorized vehicle comprises a fuel tank according to one of the above-described embodiments.

With the present invention, a method for manufacturing a fuel tank according to one of the above-described embodiments is suggested, wherein the method uses a blow molding process, and the method comprises the following steps:
providing a parison made of a plastic material inside an inner cavity of a mold, wherein the parison defines an inner cavity, and wherein the mold comprises two halves and is designed to form the desired shape of the fuel tank, and wherein the mold comprises a first opening and a second opening, the first opening being arranged at a first side of the mold and the second opening being arranged at a second side of the mold, the second side being opposed to the first side, the first opening being configured to insert the parison into the mold and the second opening being configured to insert a supporting element into an inner space of the parison;
inserting a supporting element in the inner cavity of the parison;
blowing compressed air into the parison, thereby expanding the parison;
approaching the two halves of the mold to each other, thus forming the expanded parison in accordance with the shape of the mold;
cooling the inner cavity of the mold, thereby solidifying the formed fuel tank.

The method according to the present invention allows an efficient and cost-reduced process for manufacturing plastic fuel tanks. According to the method suggested with the present invention, it is not mandatory to weld the outer surfaces of a supporting element to parts of the fuel tank. However, according to some embodiments of the present method, an outer surface of the flange may be welded to the top part or the bottom part of the fuel tank in order to increase the strengths of the attachment between the supporting element and the top part/bottom part of the fuel tank.

### BRIEF DESCRIPTION OF THE DRAWINGS

In the following, the present invention will be further described in the context of the attached figures, wherein the figures show the following:

FIG. 1 a fuel tank according to the prior art,

FIG. 2 an embodiment of a fuel tank according to the present invention,

FIG. 3 an enlarged view of the embodiment of the present invention as illustrated in FIG. 2, and

FIG. 4 an enlarged view of a further embodiment of the present invention.

### DESCRIPTION OF THE INVENTION

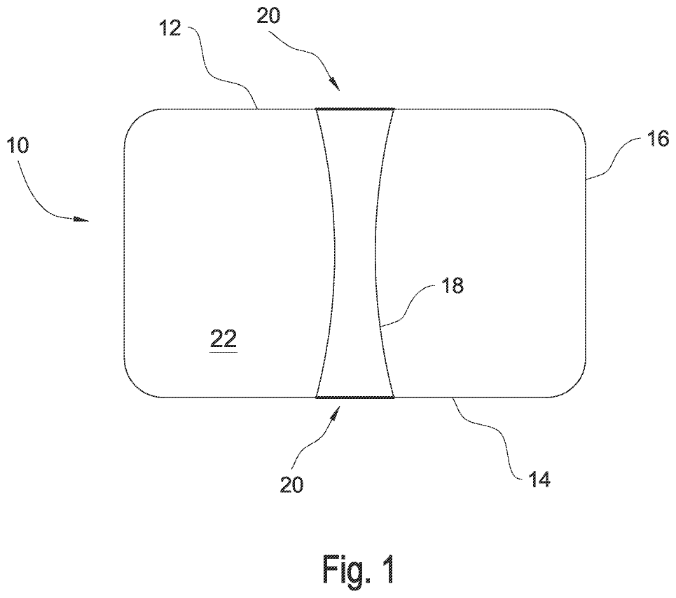

In FIG. 1, a common fuel tank 10 as known from the prior art is schematically illustrated. The fuel tank 10 comprises a top part 12, a bottom part 14 and a sidewall 16. The side wall 16 may be designed as a ring-shaped wall surrounding an inner space 22 of the fuel tank 10. Inside the inner space 22, a supporting element 18 is provided. The supporting element 18 is arranged between the top part 12 and the bottom part 14 of the fuel tank 10. The supporting element 18 comprises outer surfaces 20, which are typically welded with the top part 12 and the bottom part 14 during the process of manufacturing the fuel tank 10.

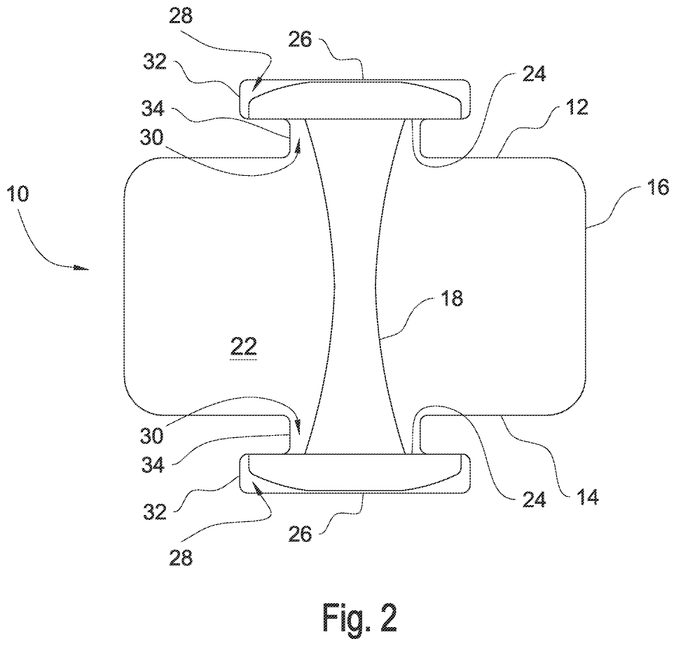

In FIG. 2, an embodiment of a fuel tank 10 according to the present invention is schematically illustrated. Similar to the fuel tank illustrated in FIG. 1, the fuel tank 10 shown in FIG. 2 also comprises a top part 12, a bottom part 14 and a side wall 16, which define an inner space 22 of the fuel tank 10. The fuel tank 10 further comprises a supporting element 18 comprising flanges 24 at its outer ends. Furthermore, the fuel tank 10 comprises integrated receiving structures within the top part 12 and bottom part 14. Each of the receiving structures comprises a first cavity 28 and a second cavity 30, wherein the width of the first cavity 28 is larger than the width of the second cavity 30 and wherein the width of the flange 24 is larger than the width of the second cavity 30 and smaller than the width of the first cavity 28. Thus, the receiving structure is configured to receive the flange 24 within the first cavity 28. Hence, the supporting element 18 can be stably attached to the fuel tank 10 in a simplified and effective manner.

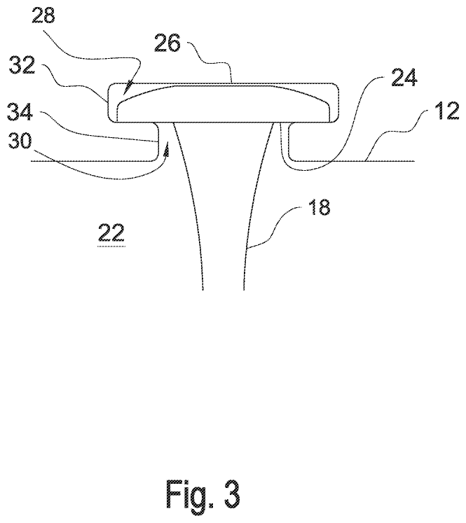

In FIG. 3, an enlarged view of the embodiment illustrated in FIG. 2 is shown. As can be seen from FIG. 3, the receiving structure comprises the first cavity 28 and the second cavity 30, wherein the width of the second cavity 30 is smaller than the width of the first cavity 28. Hence, the receiving structure formed within the top part 12 of the fuel tank 10 is configured to receive the flange 24 of the supporting element 18. As further illustrated in FIG. 3, the first cavity 28 is formed by an outer part 26 of the top part 12, which forms a first cavity outer wall, and by a first cavity side wall 32. The first cavity side wall 32 extends from the outer part 26 and defines the height of the first cavity 28. The second cavity 30 is defined by a second cavity side wall 34, which defines the height and the widths of the second cavity 30. As can further be seen in FIG. 3, the width of the flange 24 is larger than the width of the second cavity 30 and slightly smaller than the width of the first cavity 28. Hence, the flange 24 of the supporting element 18 is stably fixed within the receiving structure.

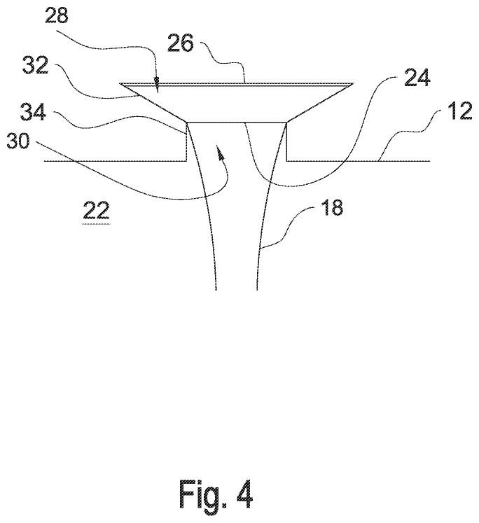

In FIG. 4, an enlarged view of a further embodiment of the present invention is illustrated. As can be seen in FIG. 4, the first cavity comprises a tapered structure, wherein the diameter of the cavity decreases in a direction from the outer part 26 of the top part 12 of the fuel tank 10 to the second cavity 30. At the same time, the flange 24 comprises a tapered structure, wherein the diameter of the flange decreases from the outer surface of the flange 24 facing the outer part 26 to the axial center of the supporting element 18. As further illustrated in FIG. 4, the tapering angle of the first cavity 28 and the tapering angle of the flange 24 are chosen identical. Hence, the flange 24 is radially centered within the first cavity 28.

### REFERENCE NUMBERS

10 fuel tank
12 top part
14 bottom part
16 side wall
18 supporting element
20 outer surface of the supporting element
22 inner space
24 flange
26 outer part of the top part/bottom part
28 first cavity
30 second cavity
32 first cavity side wall
34 second cavity side wall

1. A plastic fuel tank for a vehicle, the plastic fuel tank comprising:
a bottom part and a top part;
at least one side wall extending between the bottom part and the top part, wherein the bottom part, the top part and the at least one side wall define an inner space of the plastic fuel tank, the inner space being configured to receive fuel;
at least one supporting element, wherein the at least one supporting element has an elongated shape and comprises a longitudinal axis;
comprises a first end side and a second end side at its axial ends;
comprises a flange at the first end side or the second end side, wherein the flange comprises a flange width; and
is arranged between the top part and the bottom part;
wherein the top part or the bottom part comprises an integrated receiving structure for receiving the flange of the supporting element;
wherein the receiving structure is formed by the top part or the bottom part;
and forms a stepped cavity comprising a first cavity and a second cavity;
wherein the first cavity is defined by an outer part of the top part or the bottom part forming a first cavity outer wall, and at least one first cavity side wall extending from the first cavity outer wall; wherein the first cavity is arranged adjacent to the second cavity;
wherein the second cavity is defined by at least a second cavity side wall, and the second cavity is arranged between the first cavity and the inner space of the plastic fuel tank; and
wherein the first cavity comprises a first cavity width, and the second cavity comprise a second cavity width, wherein the first cavity width is larger than the second cavity width;
wherein the flange width is larger than the second cavity width and smaller or equal to the first cavity width; and
wherein the first cavity comprises a tapered form, wherein the width of the first cavity decreases in a direction from the first cavity outer wall to the second cavity.

2. A fuel tank according to claim 1, wherein the flange comprises an outer surface being directed away from the axial center of the supporting element, wherein the outer surface of the flange is welded to the outer part of the top part or the bottom part.

3. The tank according to claim 1, wherein the height of the first cavity is smaller than or equal to the height of the flange.

4. The fuel tank according to claim 1, wherein the width of the first cavity is equal to the widths of the flange.

5. (canceled)

6. The fuel tank according to claim 1, wherein the supporting element comprises a rotationally symmetrical shape.

7. The fuel tank according to claim 1, wherein the supporting element comprises a tapered shape, wherein the width of the supporting element decreases from its axial ends to its axial center.

8. The fuel tank according to claim 1, wherein the supporting element comprises at least one breaking point configured to break when and axial force exceeding a predetermined force threshold is applied to the supporting element.

9. The fuel tank according to claim 1, wherein the side wall, the bottom part and the top part of the fuel tank are integrally formed.

10. The fuel tank according to claim 1, wherein the side wall, the bottom part and the top part are made at least partly of a thermoplastic material.

11. The fuel tank according to claim 1, wherein the side wall, the bottom part and at the top part are made at least partly of any of the following materials: polyethylene, PE, high-density polyethylene, HDPE, polypropylene, PP, polyethylene terephthalate, PET, polystyrene, PS, polymethyl methacrylate, PMMA, polyoxymethylene, POM, polyphenylensulfis, PPS, polyphthalamide, PPA, polyether ether ketone, PEEK, polyamide-imides, PAI, or polyaryletherketone, PAEK.

12. The fuel tank according to claim 1, wherein the fuel tank is designed as a single tank or as a saddle tank.

13. A motorized vehicle comprising a fuel tank according to claim 1.

14. A method for manufacturing a fuel tank according to claim 1 by using a blow molding process, wherein the method comprises the following steps:
providing a parison made of a plastic material inside an inner cavity of a mold, wherein the parison defines an inner cavity, the mold comprises two halves and is designed to form the desired shape of the fuel tank, the mold comprises a first opening and a second opening, the first opening being arranged at a first side of the mold and the second opening being arranged at a second side of the mold, the second side being opposed to the first side, the first opening being provided to insert the parison into the mold, and the second opening being provided to insert a supporting element into an inner space of the parison;
providing a supporting element in the inner cavity of the parison;
blowing compressed air into the parison, thereby expanding the parison
approaching the two halves of the mold to each other, thus forming the expanded parison in accordance with the shape of the mold; and
cooling the inner cavity of the mold, thereby solidifying the formed fuel tank.
